(19) United States
(12) Patent Application Publication
(10) Pub. No.: US 2009/0287320 A1
(43) Pub. Date: Nov. 19, 2009

(54) System and Method for the Model Predictive Control of Batch Processes using Latent Variable Dynamic Models

(76) Inventors: John MacGregor, Dundas (CA); Mark-John Bruwer, Hamilton (CA); Masoud Golshan, Hamilton (CA)

Correspondence Address: MILLER THOMPSON, LLP, Scotia Plaza, 40 King Street West, Suite 5800, TORONTO, ON, M5H 3S1, CA

(21) Appl. No.: 12/465,352

(22) Filed: May 13, 2009

Related U.S. Application Data
(60) Provisional application No. 61/052,992, filed on May 13, 2008.

(51) Int. Cl. G05B 13/02

(52) U.S. Cl. 700/29

(57) ABSTRACT

A computer implemented method for modeling and controlling batch or transitional processes is disclosed including collecting, or initiating the collection of measurements on a plurality of process variables. The method may include creating, or initiating the creation of, a latent variable model predictive controller based on the collected measurements. The method further provides for applying or initiating the application of, the model predictive controller to predict and control at least one of the process variables to track a desired trajectory, by operation of at least one computer including one or more computer processors. A related system for implementing the method is disclosed as is a computer program operable with this method.

This application claims the benefit of U.S. Patent Application 61/052,992 filed May 13, 2008

### FIELD OF THE INVENTION

This invention relates to the control of the time varying trajectories of key process variables in industrial batch and transitional processes and more particularly to a system and method for the model predictive control of batch processes using variable dynamic models.

### BACKGROUND

A batch process may be defined as a process which transitions from some initial or starting state to some final state over a finite duration of time to produce some product with desirable properties at the final end point. In a pure batch process all materials may be charged at the start, processed through to the final time, and the product then is discharged. A semi-batch process is similar to a batch process, but may have one or more streams of materials being charged to the batch over time and/or one or more streams being discharged over time. The present disclosure refers to both of these simply as batch processes. Batch processes are used in the production of chemicals, polymers, pharmaceuticals, and biological products in batch reactors; the processing of semi-conductor products via lithography, vapor deposition, and etching; the processing of foods in batch vessels; the injection molding of polymers; batch distillation; and batch crystallization.

A transitional process is a process that may be run continuously but undergoes occasional transitions from one operating point to another, such as might occur during start-up (or shut-down) of a process or during product grade transitions whereby the process transitions over a finite period of time from one operating state to another.

The prior art discloses batch processes controlled in industry using simple univariate proportional-integral-derivative (PID) controllers which operate separately on each controlled variable (CV) using a single manipulated variable (MV) to force the controlled variable to track a desired set-point trajectory. This approach has been taken to ensure that industrial processes remain within an acceptable operating window with respect to safety and with respect to the production of high quality product. This control allows for general control where CV's associated with the industrial process are held within a relatively tight operating window. This general control may experience difficulties when there is a significant variance that ensues such as an introduction of a raw material with significantly difference characteristics. There is a need for more advanced control of batch processes especially when the process characteristics change significantly during the course of the batch. There is a further need for multivariable control of trajectories in batch processes to achieve this advanced control.

The model predictive controllers (MPC's) applied in industry (by vendors such as Honeywell, Aspen Technologies, Emerson, Rockwell) are generally based on linear input-output models or linear state space models identified from plant data. A quadratic objective function penalizing the deviation of the CV's from their set-points and penalizing excessive manipulated variable (MV) movement (move suppression) is optimized on-line using Quadratic Programming (QP), subject to various operating and safety constraints on the variables. The result of the optimization is a set of MV trajectories over a specified control horizon. Only the specified MV solutions to be implemented for the next time interval are then usually written out as set points to be implemented by the plant control layer (such as a Distributed Control System (DCS) or Programmable Logic Controller (PLC)). The MPC algorithm is then run again at the next control interval and new MV trajectories computed, and the process repeated. The linear models used generally relate only the set of manipulated variables to the set of controlled variables and ignore other measured process variables (xₘₑ) that are not directly controlled or manipulated. However, some MPC systems do allow explicitly measured disturbance variables to be included in the model, provided explicit models for their effects on the controlled variables are available.

Nonlinear MPC's have recently been developed and are available from several control vendors (see additional related information accounting for the nonlinear behavior of the process through the use of the nonlinear model). Some of them, based on fundamental, non-linear models of the process are, or could be, applicable to the multivariable control of batch processes.

The disadvantages are that (i) a good theoretical model of the process is necessary and such models are very time consuming and costly to develop; (ii) the theoretical models often do not include a description of the behavior of all of the measured variables available on the system (e.g. agitator power) that are useful in providing information on the disturbances in the system; and (iii) the nonlinear MPC's are very computationally intensive and the optimization may not be able to be completed in the required time interval, especially for a short-duration batch process.

Prior art empirical modeling methods have used a form of regression to build models relating past inputs (manipulated variables (u) and sometimes measured disturbance variables) to the future controlled variables (y). These methods may be satisfactory if the process is a continuous one operating about a fixed point so that the model is valid for every time point in the past and the future, ie. the model procedure uses the data to find one fixed model that is valid at all times.

In batch and transitional processes the process is time varying throughout the batch or transition and a fixed model may not be adequate. Therefore, there is a need for a MPC formulation aimed at transitions in continuous processes or batch processes that is based on nonlinear theoretical models (nonlinear differential equation models built for fundamental mass and energy balance equations) that can model this nonlinear time varying behavior.

There is also a need for empirical latent variable models for batch processes, which are built using data collected from the process and are able to model the time varying, nonlinear behavior of these batch and transitional processes. Thus they may accomplish what the fundamental differential equation models do but with all the ease of model building and computational speed advantages of the linear regression models. These models may also have an advantage over other regression-based models in this problem because they are models that may extract all the useful information from the data into very low dimensional spaces (ie. into latent variables) thereby giving very low dimensional, parsimonious models that are not over-parameterized and thus are more robust (less sensitive to slight variations in the data used to build them). This also allows these models to use all the measured variables available and not be forced to use just the manipulated inputs (variables) (MV's) and controlled variables (CV's). The result may be a more accurate prediction of the future behavior of the process.

U.S. Pat. No. 6,826,521 issued to Hess et al. discloses the standard practice for advanced industrial process control in processes of the type described above is to use linear, multivariable, model predictive controller (MPC) software. Other prior art publications further expand on this practice such as: the Setpoint, Inc. product literature dated 1993 entitled “SMC-Idcom: A State-of-the-Art Multivariable Predictive Controller”; the DMC Corp. product literature dated 1994 entitled “DMC.TM.: Technology Overview”; the Honeywell Inc. product literature dated 1995 entitled “RMPCT Concepts Reference”; and Garcia, C. E. and Morshedi, A. M. (1986), “Quadratic Programming Solution of Dynamic Matrix Control (QDMC)”, Chem. Eng. Commun. 46: 73-87. The typical MPC software allows for model scheduling (i.e. changing the model gains and/or dynamics) to improve control performance when operating on a nonlinear and/or time-varying process. The controller uses new models that are generally calculated in an off-line mode, or may be calculated by an adaptive algorithm that uses recent operating data.

The prior art includes many examples of the use of model-based control systems employing both linear and nonlinear methodologies for control. Prior art MPCs refers to linear controllers, see for example: U.S. Pat. No. 4,349,869 to Prett et al.; U.S. Pat. No. 4,616,308 to Morshedi et al.; U.S. Pat. No. 5,351,184 to Lu et al.; and U.S. Pat. No. 5,572,420 to Lu. To handle nonlinear, time-varying processes, these controllers may use gain scheduling, adaptive model estimation, or robust controller tuning. These approaches typically encounter implementation problems and/or performance degradation for the types of processes and operating conditions described previously.

There have been a few patents issued for nonlinear model-based control methodologies. In particular, U.S. Pat. No. 5,260,865 to Beauford et al. describes a nonlinear model-based control strategy for a distillation process which employs a nonlinear model to compute liquid and vapor flow rates required for composition control. Sanner and Slotine (U.S. Pat. No. 5,268,834) employ a neural network together with other nonlinear control strategies to provide adaptive control of a plant. Bartusiak and Fontaine (U.S. Pat. No. 5,682,309) developed a reference synthesis technique in which the controller attempts to make a nonlinear plant follow a specified reference trajectory. U.S. Pat. No. 5,740,033 to Wassick et al. describes an MPC that employs a real-time executive sequencer and an interactive modeler to find the optimized set of control changes for a nonlinear process. Large, nonlinear control problems are difficult to solve in an on-line operating environment. The solver must be fast and robust.

One prior art publication, Flores-Cerillo, J. and J. F. MacGregor, (2005) “Latent variable MPC for Trajectory Tracking in Batch Processes, J. Process Control, 15, 651-663, discloses an industrial applications on MPC's for batch processes based on Latent Variable methods. That publication is related to one of the algorithms in this methodology in that it uses a simpler version of the observation-wise unfolding with time-lagging approach.

However, there is a need for the control method and related algorithm to eliminate errors in the handling of external disturbances throughout the batch. There is a further need for the control algorithm to allow for the use of multiple models, one for each different phase of the batch. In one aspect of the present invention, the Model Predictive Controllers based on Latent Variable Models (LVM) may allow one to achieve essentially the equivalent control of non-linear batch processes as is possible with the use of non-linear MPC based on non-linear fundamental models of the process. However it may do so with linear LVM's that allow for fast on-line solution and that are easily identified from data collected from the industrial batch process. The MPC calculations may also be computed very rapidly on-line with very modest solvers, thereby making it a powerful practical solution to batch MPC.

There is a further need to differentiate between high level control and low level control in the control of a batch process. High level control refers to controlling the process from the perspective of meeting specific performance targets, measured upon completion. The process may be analyzed from the perspective of whether it will result in performance within a specific window based on data upstream, and if not then making midpoint adjustments. Usually this type of control is made possible by extracting a wealth of information based on timed histories.

Low level control refers to controlling the timed history of factors such as temperature, pressure etc., and tracking these trajectories. Prior art discloses proportional-integral-derivative (PID) controls where control may work well in some period but not in others. Prior art discloses MPC based on certain types of linear models that are applied to continuous processes. Prior art also discloses non-linear model predictive control based on theoretical models applied to batch processes. There is a need for a much simpler approach that will also enable tight control over the trajectories.

There is further a need to have a predictive model with wide applicability to the control of variables such as temperatures, pressures and concentrations in batch processes for the manufacture of chemicals, pharmaceuticals, processed foods, semi-conductors, etc.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 illustrates in flow chart form the method of one embodiment of the present invention.

FIG. 2 illustrates batch-wise unfolding of batch data according to one embodiment of the present invention.

FIG. 3 illustrates time lagged, observation-wise unfolding of batch data according to another embodiment of the present invention.

FIG. 4 illustrates the combined batch-wise and observation-wise unfolding according to one embodiment of the present invention.

FIG. 5 illustrates multiphase construction and overlapping in a batch-wise unfolded dataset according to one embodiment of the present invention.

FIG. 6 illustrates an observation containing missing data and its corresponding PCA model according to one example of the present invention.

FIG. 7 illustrates a hardware and software infrastructure according to one embodiment of the present invention.

FIG. 8 illustrates a schematic of the reactor used in the LV-MPC simulation example of the present invention.

FIG. 9 illustrates in graph form control based on the latent variable scores, and a 6-phase PCA model built using batch-wise unfolded data, set-point tracking only.

FIG. 10 illustrates in graph form control based on manipulated variables (u), and a 6-phase PCA model built using batch-wise unfolded data, set point tracking only.

FIG. 11 illustrates in graph form control based on scores, and a 6-phase PCA model built using batch-wise unfolded data, and a random walk disturbance.

FIG. 12 illustrates in graph form control based on manipulated variables (u), and a 6-phase PCA model built using batch-wise unfolded data, and a random walk disturbance.

FIG. 13 illustrates in graph form control based on scores, and a 5-phase PCA model built using observation-wise unfolded data with time-lagging, set-point tracking only.

FIG. 14 illustrates in graph form control based on manipulated variables (u), and a 5-phase PCA model based on observation-wise unfolding with time-lagging, set-point tracking only.

FIG. 15 illustrates in graph form control based on latent variable scores, and a 5-phase PCA model built using observation-wise unfolded data with time-lagging, and a random walk disturbance.

FIG. 16 illustrates in graph form control based on manipulated variables (u), and a 5-phase PCA model based on observation-wise unfolded data with time-lagging, and random walk disturbance.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION

### Overview

The present invention provides a method for process modeling and control, and a software implementation of this method which includes an empirically identified latent variable model of a batch or transitional process, and, based on that model, a predictor for the future trajectories and an optimal control method (and related algorithm, in one implementation thereof a latent variable model predictive control, LV-MPC) for trajectory tracking of specified variables. This model may be based on Latent Variable models (linear or non-linear) that efficiently model the time varying non-linear behavior of the batch evolution, that easily incorporate into the model all measured variables, that are easily identified from process data, and that require modest computational effort and computing time for their use in the prediction of future trajectories and for the computation of the controls. These advantages make this approach uniquely suited for real-time application to industrial batch and transitional processes.

In one implementation of the present invention LV-MPC may consist of a model predictive controller that is designed to manipulate and/or control process variables in the batch or transitional process. The controller interfaces with or may be included in commercially available process control systems that are known in the art such as Emerson, Aspen Technologies, Honeywell, Rockwell Automation and others. The controller may also be implemented or included as a toolkit or hardware component designed to interface with one or more computers.

In one aspect of the present invention, a computer implemented method for modeling and controlling batch or transitional processes comprises the steps of: (a) collecting, or initiating the collection of measurements on a plurality of process variables; (b) creating, or initiating the creation of, a latent variable model predictive controller based on the collected measurements; and (c) applying or initiating the application of, the model predictive controller to predict and control at least one of the process variables to track a desired trajectory, by operation of at least one computer including one or more computer processors.

Without limiting application of the invention, the method has a wide range of potential industrial applications in the batch manufacturing industry. Some examples of the present invention may be but are not limited to: (i) the control of temperature, pressure and concentration trajectories in the batch manufacture of chemicals and polymers, (ii) the control of pH, dissolved oxygen, and nutrient concentration trajectories in the batch manufacture of biological materials, (iii) the control of temperature, supersaturation and particle growth trajectories in batch crystallization, (iv) the control of temperature, mixing intensity and viscosity trajectories in food processing, (v) the control of partial pressure and temperature trajectories in vapor phase deposition or etching in the semi-conductor industry.

The present invention also provides for applying the latent variable model predictive controller imputing unmeasured further values of at least one process variable of batch or transitional processes using a missing data imputation method for a latent variable model (such as Projection to the Model Plane (PMP), Trimmed Score Regression (TSR), and Conditional Mean Replacement (CMR) methods), or some variations of these including those which weight the data in some manner to improve the imputation and the conditioning of the imputation.

In another aspect of the present invention, the method uses Latent Variable (LV) Models which may be based on one of the latent variable estimation methods such as Principal Component Analysis (PCA), Partial Least Squares (PLS), Independent Component Analysis (ICA), Reduced Rank Regression (RRR), Canonical Correlation Analysis (CCA) or other subspace methods related to these.

In another aspect of the present invention, the latent variable models (LVM) may be formulated in different possible ways, but preferably it will depend upon the particular batch or transitional process and problem being considered. These possibilities include: (i) a LVM based on unfolding the batch data in a batch-wise manner (i.e. with all the measurements for a batch in one row of the matrix); (ii) a LVM based on unfolding the data in a time-lagged observation-wise manner (i.e. with each row of the data matrix containing a vector of lagged observations over a finite time period on all the variables); (iii) a LVM based on a combination of the above two unfolding methods; and (iv) multiple LVM's whereby different LV models, based on any of the above unfolding methods, are used to model different phases of the batches. Non-linear versions of these Latent Variable models may also be used, but appear to provide no or modest improvement over the linear algorithms and lead to additional computational effort and complexity of the computer program of the present invention.

In a further aspect of the present invention, the models may be identified from data collected from the batch or transitional process while it is in operation under closed-loop control. Data from both historical batches operating with the existing controllers active and from some batches with designed experimental variations added on top of the manipulated variables are used for the model identification.

In an implementation of the present invention, model predictive controllers (MPCs) may be based on a quadratic optimization solution (quadratic programming if constraints are present or unconstrained least squares if there are no constraints) in either the space of the manipulated variables or in the space of the latent variables. In the latter case the manipulated variables may then be calculated from the optimized values of the latent variables using the latent variable model.

In a further aspect of the present invention, the predictions of the future trajectories of the process variables and the calculation of the model predictive controller are, in some cases, formulated to use a growing time history of past data and a shrinking forward horizon for future controls as time progresses through the batch from the start to the end.

The present invention also provides for a system for modelling and controlling batch or transitional processes comprising: (a) one or more computers including or being linked to a computer program, the computer program including computer instructions which when made available to the one or more computers, is operable to provide: (i) a control layer for collecting or initiating the collection of measurements on a plurality of process variables, and further for creating or initiating the creation of a latent variable model predictive controller based on the collected measurements, wherein the control layer is operable to apply or initiate the application of the model predictive controller for predicting and controlling at least one of the process variables to track a desired trajectory.

The present invention further provides for a computer program comprising computer instructions, which when made available to one or more computers, are operable to define on the one or more computers: (a) a control layer configured to collect or initiate the collection of measurements on a plurality of process variables, and to create or initiate the creation of a latent variable model predictive controller based on the collected measurements, wherein the control layer is operable to apply or initiate the application of the model predictive controller predict and control at least one of the process variables to track a desired trajectory.

The Latent Variable MPC technology discussed in the present invention has several unique aspects that provide it with advantages over both the linear and the nonlinear MPC technologies described above. In one aspect of the present invention, it may use efficient, low dimensional Latent Variable (LV) models to describe the time evolution of all the variables in the batch or transitional process. This modeling approach offers several advantages in the control of these processes as:
a. the LV models can model the time-varying nonlinear behavior of batch and transitional processes;
b. unlike the fundamental models used in nonlinear MPC, LV models may not require fundamental knowledge of the process, and may be easily developed using data from normal process operation and some designed closed-loop identification experiments;
c. they may easily and efficiently accommodate all the variables measured throughout the batch (not only the manipulated and controlled variables) thereby providing information on disturbances entering the process without the need for explicit disturbance models;
d. they provide for robust models because they are reduced dimensional models that are not over-parameterized compared to input-output or artificial neural network models; and
e. they allow for the whole range of monitoring and diagnostic methods developed for these models in other applications to be applied to monitoring and detecting and diagnosing problems with the incoming data.

In another aspect of the present invention, the LV-MPC technology may provide the following advantages over alternative nonlinear MPC methods when applied to batch or transitional processes such as:
a. it provides nonlinear control but with very computationally efficient Quadratic Programming algorithms comparable to linear MPC and the control actions may easily be computed in real time, even for fast batch or transitional processes; and
b. the statistical missing data imputation methods used in the algorithm for the prediction of the future trajectories may provide a completely novel approach to the state estimators used by existing MPC's as these imputation methods may also allow for improved predictions through the use of additional measured variables that provide information on how disturbances will affect the future trajectories, discussed above.

A schematic of the information and calculation flow of the method of the present invention, in one embodiment thereof, is illustrated in FIG. 1. This schematic may be similar to other MPC's with the exceptions that the LVM approach may allow for easy detection of bad measurements (outliers) and of any abnormal situations arising in the new data collected from the process at each time. In one aspect of the present invention, the latent variable model allows disturbance information to be readily inferred from all available measurements.

In one implementation of the present invention the general workflow may consist of building the model, developing the model predictive controllers and implementing the technology. The first step may provide for data from a plurality of past batches operated under normal operating conditions with an existing control system being extracted from the data historian. The data may consist of the time histories on all measured variables, sampled every second or so, depending upon the sampling interval to be used for control: often between 1 to 10 seconds but it may depend on how fast control is needed. It will be understood that in a batch process that is very fast then faster sampling is needed and vice versa.

In a further aspect of the present invention, some additional batches are run with some designed experimental signals (random binary signals (ie. either high or low values) added on top of the manipulated variable signals being sent to the control actuators (eg. valves for flow control). Other binary signals and control actuators are considered. These signals are added throughout the duration of the batch. Data from these designed experimental batches may help to give a better model. The data collected from all these batches may be combined and then unfolded in one of the ways explained in further detail below. A latent variable model may then be built using these data. The latent variable model used may be based on a Principal Component Analysis or on other latent variable methods.

In another aspect of the present invention, the PCA or other model may then be used in the manner described below to predict the future behavior of new batches and to compute the optimal LV-MPC control actions over the future. The control may then be performed on a new batch using the data flow. The control actions computed for application at the current time interval are then sent to the different layers of the implemented method to the final control elements (eg. valves). This step may then be repeated at each time interval.

In one embodiment of the present invention the first step consists of collecting the data (100). Once the data is collected it may optionally be preprocessed (101) which may include mean centering and scaling the data. Once the data is preprocessed, there may be outlier and abnormal situation detection (103). Following that step, prediction of future trajectories (103) may be computed followed by optimal control calculations (104). After the optimal control calculations (104) have been completed output of control actions to actuators (105) may be instituted.

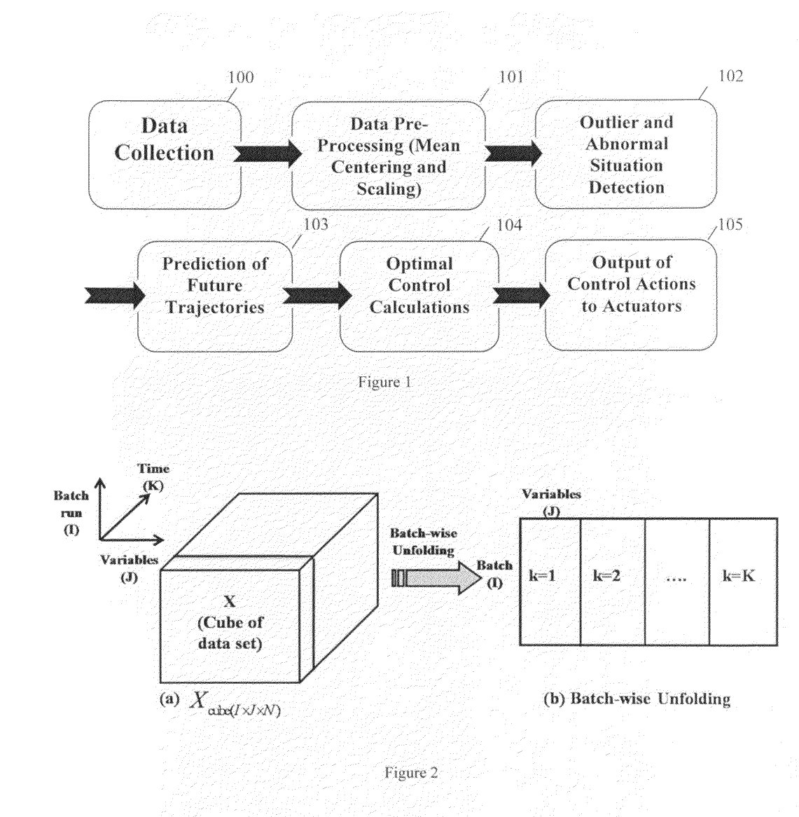

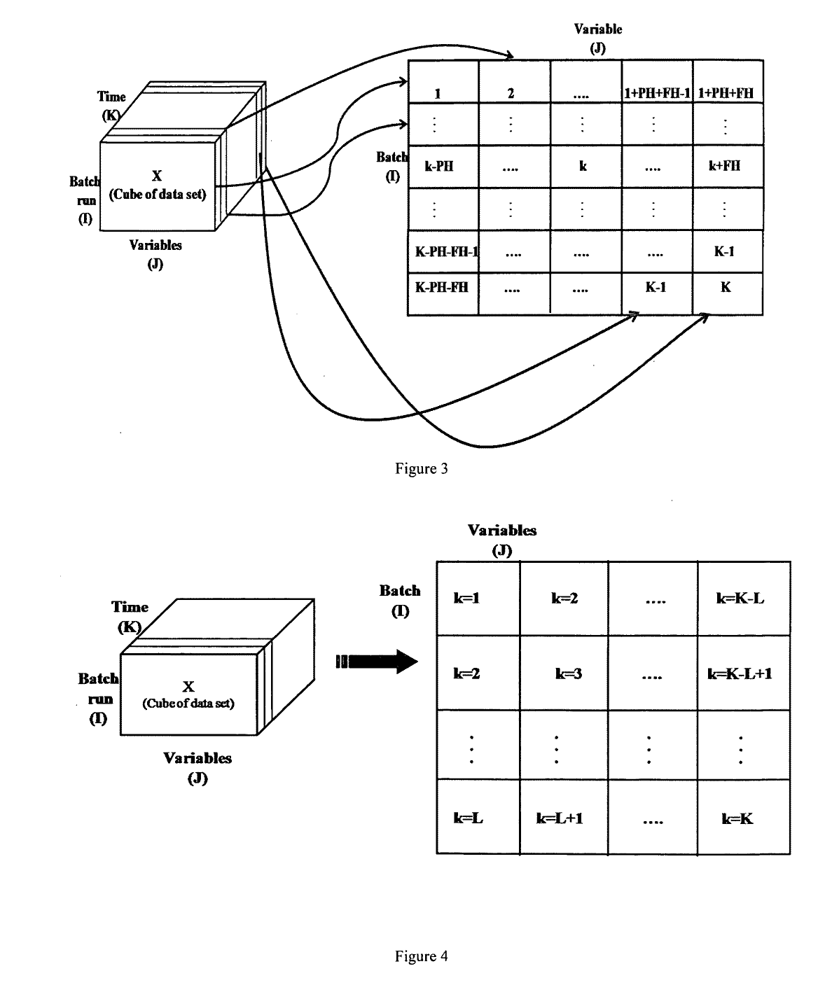

The present invention contemplates various formulations of the latent variable models, as particular embodiment thereof may have certain advantages and disadvantages. The choice of the LVM formulation to use may depend upon the particular features of the batch process involved. Possible formulations of the LVM's arise from different ways of unfolding the data arrays collected from the batch process: (i) batch-wise unfolding of the data (as illustrated in FIG. 2), and (ii) time-lagged observation-wise unfolding. (as illustrated in FIG. 3), (iii) combined batch-wise unfolding and time-lagged observation-wise unfolding (as illustrated in FIG. 4) The methodology will be discussed first using the batch-wise unfolded LV modeling (FIG. 2) and then the modifications to use time-lagged observation-wise unfolding (FIG. 3) and the combined unfolding approach (FIG. 4) will be explained. Other variations of unfolding the data are contemplated. The use of multiple LVM's whereby different LV models, based on any of the above unfolding methods, are used to model different phases of the batch or transitional process is also a formulation and will be explained.

Data Requirements and Rearrangement of the Data

In one aspect of the present invention, the training data needed to build the LV-MPC controller may consist of data from historical batches executed under standard manufacturing conditions with existing controllers in operation, augmented with data from some batches in which designed experiments have been implemented to obtain causal information between the manipulated and controlled variables. One approach may be to add a random binary sequence (RBS) dither to each manipulated variable output under closed-loop conditions. The choice of closed-loop identification may be used for minimizing disruption to the batch recipe.

In one implementation of the present invention, the identification approach may be sequential in nature. A preliminary data set may be collected using the methods described above. This may enable the first-generation model to be estimated and the corresponding LV-MPC system commissioned. Once commissioned, data from subsequent batches, under the new control regime, may be collected and added to the training data. The model may then be re-estimated and a revised controller commissioned. This iterative modeling process may be repeated several times.

### Batch-Wise Unfolding of the Data

One form of batch process modeling was presented and popularized by prior art publications such as: Nomikos, P. and MacGregor, J. F., (1994), “Monitoring of Batch Processes Using Multi-Way Principal Components Analysis”, Amer. Inst. Chem. Eng. J., 40, 1361-1375; and P. Nomikos and J. F. MacGregor, (1995). “Multi-Way Partial Least Squares in Monitoring Batch Processes”, Chemometrics & Intell. Lab. Systems, 30, 97-108. This method has seen many industrial applications for process data analysis and process monitoring.

One advantage of this invention may be the use of this modeling approach for the control of batch trajectories. The models may be identified from data collected on past batches under feedback control and data collected from some batches in which a designed input sequence is superimposed upon the existing feedback controller output. The batch data (X) may be unfolded as illustrated in FIG. 2 with each row in the unfolded matrix containing all the measured variables (J) at every time period (K) for that particular batch (I). The data may be centered about the mean of each column and scaled to unit variance. Other centering and scaling techniques may be applied and are contemplated in the present invention.

In one implementation of latent variable models built on this batch-wise unfolded data, the advantage is provided of enhanced ability to model the nonlinear behavior of batch processes. By subtracting the mean or some reference trajectory from the raw measurements on each of the variables in the preprocessing step (101 in FIG. 1) the major nonlinear effects exhibited in these trajectories may be removed. LV models using this mean corrected batch-wise unfolded matrix then model the time-varying covariance structure in terms of loading parameters for each time point. This implementation of the present invention may lead to effectively providing a locally linearized model among all the variables at each time throughout the batch.

In one example of the present invention, the first step in formulating the Controller may be to build a Latent Variable model on training data from the batch process. Any one of the latent variable methods may be used, but PCA may be preferable and is illustrated here. The data may be arranged into the matrix, X. Each row of X, the row vector, x^{T}, contains all the relevant data from a particular batch, arranged as,

x^{T}=[ζ₁^{T}, ζ₂^{T}, . . . , ζₖ^{T}, . . . , ζ_{K}^{T}] (1)

where,

ζⱼ^{T}=└xₘₑ^{T}y_{cv}^{T}yₛₚ^{T}u_{c}^{T}┘ⱼ (2)

and,
subscript j=the j^{th} time point
xₘₑ=the vector of measured variables at a point in time
y_{cv}=the vector of controlled variables at a point in time
yₛₚ=the vector of the controlled variable set points at a point in time
u_{c}=the vector of manipulated variables at a point in time

Then,

$$X = [ \begin{matrix}{x}_{1}^{T} \\ {x}_{2}^{T} \\ ⋮ \\ {x}_{I}^{T}\end{matrix} ] \qquad ( 3 )$$

The matrix, X, has dimensions I×S, where I is the number of batches and S=M×K, M being the number of variables and K the total number of time points. In this example, each principal component of the PCA model is captured by a loading vector, p, of length S.

### Time-Lagged, Observation-Wise Unfolding

In another aspect of the present invention the time-lagged, observation-wise unfolding may be used. This form of unfolding of the batch data (FIG. 3) unfolds the data (X) vertically where the measurements of each variable (J) in a given batch (I) may be unfolded in a column and this is repeated for PH+FH time lags as additional columns (where PH and FH indicate a past horizon and future horizon as defined in the controller objective). The unfolded time-lagged data for each batch may then be arranged as illustrated FIG. 3 and below in equations (4) and (5) where M represents the data matrix for one batch.

$$\begin{matrix}{ζ}_{i}^{T} = [ {x}_{me}^{T} , {y}_{cv}^{T} , {u}_{c}^{T} , {y}_{sp}^{T} ] & ( 4 ) \\ M = [ \begin{matrix}{ζ}_{1}^{T} & … & & … & & … & {ζ}_{1 + PH + FH}^{T} \\ ⋮ & ⋱ & & & & ⋰ & ⋮ \\ {ζ}_{i - PH}^{T} & … & {ζ}_{i - 1}^{T} & {ζ}_{i}^{T} & {ζ}_{i + 1}^{T} & … & {ζ}_{i + FH}^{T} \\ ⋮ & ⋰ & & & & ⋱ & ⋮ \\ {ζ}_{N - PH - FH}^{T} & … & & … & & … & {ζ}_{N}^{T}\end{matrix} ] , \\ X = [ \begin{matrix}{M}_{1} \\ ⋮ \\ {M}_{k} \\ ⋮ \\ {M}_{I}\end{matrix} ] & ( 5 )\end{matrix}$$

A PCA model on this unfolded data may provide a fixed (non time-varying) model of the batch over each window of time lags used. It may therefore not model time-varying behavior within this window, but by using multiple time windows it may provide time-varying models between windows. This approach may have the advantage of requiring data from fewer batch runs for identifying the latent variable model, since a simpler, fixed (non-time varying) model is being identified within each phase.

### Combined Batch-Wise and Observation-Wise Unfolding

In another alternative implementation of the present invention a combination of batch-wise and observation-wise unfolding may be used. This form of unfolding of the batch data unfolds the data as in batch-wise unfolding (FIG. 2) but augments the batch-wise unfolded data matrix with a limited number (L) of observation-wise unfolded matrices as shown in FIG. 4. It may also be viewed as several (L) batch-wise unfolded matrices lagged by time placed one below the other.

A latent variable model built on this unfolded data matrix will have some of the benefits of both of the two previous approaches. In particular, it may allow the model to capture some of the nonlinearities within each phase (an advantage of batch-wise unfolding) and also require less batch data for the model identification (advantage of observation-wise, time lagged unfolding).

### Latent Variable (LV) Models

In one example of the present invention, the unfolded matrices of FIGS. 1-3 may be considered as matrix X_{(a×b)}, the PCA model may be of the form:

X=TP^{T}+E (6)

T=XP (7)

Where T is a (a×A) matrix (A≦b) of latent variable scores that summarizes the major differences among the batch trajectories, and P is a (b×A) matrix of loadings that show how the latent variable scores are related to the trajectory data (X). The score values of the A latent variables for each batch summarize the time varying behavior of its trajectories relative to all the other batches.

Various Latent Variable regression methods including Partial Least Squares (PLS), Redundancy Analysis (RA) (sometimes called Reduced Rank Regression (RRR)), and Canonical Correlation Analysis (CCA) may be used to estimate a latent variable space as disclosed in prior art A. J. Burnham, R. Viveros-Aquilera and J. F. MacGregor, 1996. “Objective Function Frameworks for Comparing Latent Variable Methods for Multivariate Regression”, J. Chemometrics, 10, 31-46 (Burnham et al.). These latent variable regression methods differ primarily by breaking out the variables to be predicted (Y) from the others (X) and have the latent variable model structure:

X=TP^{T}+E (8)

Y=TC^{T}+F (9)

T=XW* (10)

The latent variable regression models differ only by slight variations in the objective function used to estimate the reduced set of latent variables (Burnham et al.). Any of them may be used to estimate a suitable set of latent variables for control and for prediction and then be used in the methods outlined in this present invention.

In one implementation of the present invention, latent variable modeling of the batch using the batch-wise unfolding approach (FIG. 2) may lead to a very large global LV model (for the entire M*K intervals). This may not be desirable as it may require many latent variables which implies many batches may be needed in the training set. It may lead to ill-conditioned matrices in the model used during the control computations, and it does not focus on the local behavior of the trajectories. Furthermore, utilizing a large model in the control action calculations at each sample time increases the computational effort for prediction and control, which might be a problem in on-line applications. Therefore, the use of multi-phase LV models may be preferable.

In one aspect of the present invention, the multiphase modeling approach is based on identifying multiple phases within the batches, partitioning of the dataset according to these phases, considering overlap between two adjacent phases and building latent variable models for each phase. The proper selection of the number and location of the phases may be more important in the time-lagged observation-wise unfolded approach where it is important to select phases during which the covariance structure of the data is reasonably constant. In the batch-wise unfolded approaches non-linear time varying covariance structures are already accounted for and hence the location of phases may be less important and the number of phases may be selected primarily to simply reduce the phase size so as to improve the local predictability of the models, minimize the ill-conditioning, and reducing the computation time.

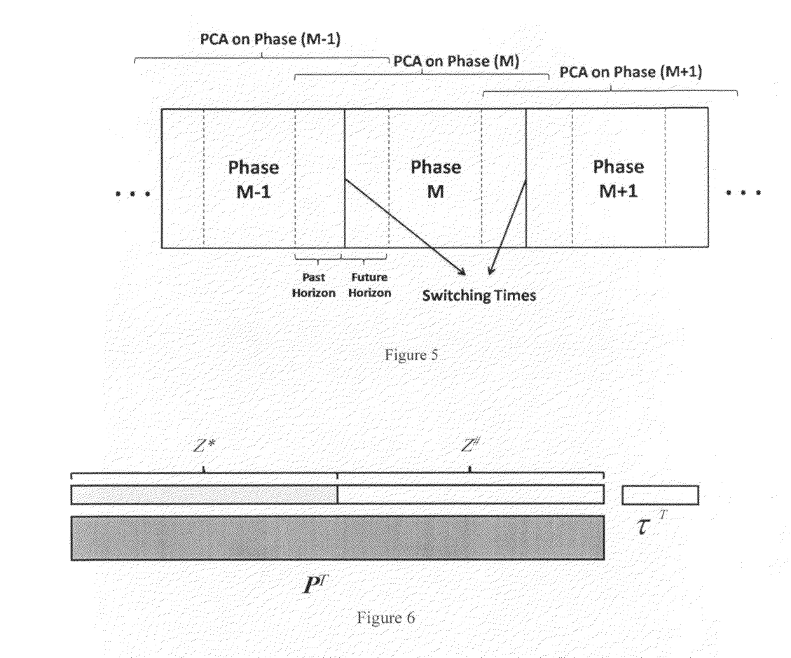

Once the phases have been determined, latent variable models are built for each phase and MPC may be applied in each phase based on the model for that phase. To build the latent variable models in each phase it is desirable to use not only the data from that phase, but also overlapping data between any adjacent phases to guarantee the smooth switching of models between phases (bumpless transfer) during the trajectory tracking control. The delineation of phases and the overlapping of data between phases according to one aspect of the present invention are illustrated in FIG. 5.

One may use data over as many sample times as the selected model future horizon (fh) from the next phase and the data of as many sample times as the selected model past horizon (ph) from the previous phase as shown in FIG. 5. Then the current phase may be augmented with these two wings and the dataset is unfolded through either batch-wise or observation-wise with time-lagging or other method. Then a latent variable model may be built based on the augmented phase. The algorithm may switch between phases as soon as the batch reaches the sample time corresponding to the border of the original phases. As a result the algorithm may not face the expanding past horizon and shrinking future horizon except at the beginning and end of the batch, respectively. The values of the fh and ph depend on the type of process. The range of 10-30 sample times is typical although any number of steps in the past and future may be used for modeling and prediction. It should be understood that the range will depend upon the process and the sampling rates used.

Other models besides PCA may also be used. Independent Component Analysis may be used similarly to PCA. Some of the other latent variable regression based methods may alter things somewhat. Instead of putting all the variables together in one X matrix one may break out the variables to be predicted in the future (ie. the future controlled variables (y) and the other future measured variables xₘₑ) into a Y matrix. PLS, CCA and RRR (LV regression methods) may still find a LV model as equations (8), (9) and (10) as shown above and the prediction and control calculations may have to be modified accordingly, but may result in very similar equations and would optimize the same objective function. The prediction accuracies of other models may also be similar. It will be understood that the essential issue is not the specific type of LV modeling method used, but the use of one of these efficient estimation methods to get a reduced dimensional latent variable model.

### Prediction of Future Trajectories

Prediction plays an important role in the MPC algorithm since the optimization problem embedded in the MPC needs future prediction of the outputs up to the prediction horizon. The prediction method depends on the type of model being utilized in the MPC. For most linear and nonlinear dynamic models used for existing MPC algorithms, the future prediction may be calculated using integration of the dynamic model over the prediction horizon (fh) and adapting it assuming a simple random walk type disturbance model on the controlled variable (CV).

As mentioned above the LV models may be able to easily incorporate all the measured variables throughout the batch (not just manipulated variables, MV's, and CV's) without being over-parameterized. These measured variables (eg. agitator power, coolant temperature, other temperature/pressure/force measurements around the process, etc) contain within them valuable information on disturbances that may affect the future behavior of the important variables being controlled (y's=CV's). Latent variable models then use not only the manipulated variables (u) to predict the future controlled variables (y) but all of these ancillary variables that contain important information on the future. Then during on-line LV-MPC calculations for a new batch the model may use efficient missing data imputation methods to simultaneously use all this information to predict the future in any batch phase.

Several missing data imputation methods have been proposed for latent variable models in the literature. For batch processes the aim is to predict the final latent variable scores at the end of any phase and then, from the PCA model of the X-space (Equation (6)) or the latent variable regression model of the Y-space (Equation (9)), the values of all the missing trajectories over the remainder of the phase can be estimated. Nelson et al. (1996) presented an analysis of several methods including the Single Component Projection (SCP) method, the Projection to the Model Plane (PMP) method, and the Conditional Mean Replacement (CMR) method. Arteaga, F., Ferrer A., (2002), discussed the methods proposed by Nelson et al. (1996) as well as some other methods including a Trimmed Score Regression (TSR) method. Since the PMP and TSR are the methods found to have greatest promise in this study, they are briefly discussed below but it should be understood that the application of the present invention is not limited to these models.

### Projection to the Model Plane (PMP)

The PMP method was used by Nomikos and MacGregor, in both 1994 and 1995 prior art publications above, in their original batch monitoring methodology. It projects the new vector of observations with missing data onto the plane defined by the latent variable model (Equations (6) and (7)) to obtain an estimate of the missing part of the data vector that is consistent with the model.

In one example of the present invention, a new observation (z) may be divided in two parts as shown in FIG. 6:

z^{T}=[z*^{T}z^{#T}] (11)

Where, z* are the known data and z^{#} are the missing data. For the batch process analysis, z* corresponds to the past data and z^{#} corresponds to the future data. The loading matrix may also be divided into two parts in the same way as z.

P^{T}=[P*^{T}P^{#T}] (12)

Thus, the PCA model can be partitioned as:

$$z = [ \begin{matrix}{z}^{⋆} \\ {z}^{\#}\end{matrix} ] = [ \begin{matrix}{P}^{⋆} τ \\ {P}^{\#} τ\end{matrix} ] \qquad ( 13 )$$

where τ is the vector of latent variable scores, τ^{T}=[t₁, t₂, t_{A}]. If the known part of the data is used for score estimation, the following relation is obtained (Neslon et al., 1996):

τ=(P*_{1:A}^{T}P*_{1:A})⁻¹P*_{1:A}^{T}z* (14)

Subscript 1:A means that A principal components are considered in the PCA model. The estimates of the trajectories of all the variables for the remainder of the batch phase (z^{#}) are then obtained from equation (13).

### Trimmed Score Regression Method (TSR)

In another alternative of the present invention TSR may be used. For this method the same partitioning may be applied to the data. The score may be computed based on the assumption that the known part of the data is the complete data in the observation. Thus,

τ*=P*^{T}z* (15)

And the real scores are calculated by regressing the real scores (τ) on the fake scores (τ*). Finally, the score estimation formula is (Arteaga and Ferrer, 2002):

τ=Θ_{1:A}P_{1:A}*^{T}P_{1:A}*(P_{1:A}*^{T}P_{1:Q}*Θ_{1:Q}P_{1:Q}*^{T}P_{1:A}*)⁻¹P_{1:A}*^{T}z* (16)

Where, Θ is the covariance matrix of the scores (Θ=(T^{T}T)/I)) in the PCA model, where I is the total number of batches in the dataset and T is the matrix of scores from all batches. The number of scores considered in Θ(Q) can be more than or equal to A.

### Control

This section illustrates several variations of the control methodology based on different combinations of latent variable models, obtained from different types of unfolding, and on solutions of the optimization problem in different variable spaces (solution in the latent variable space and solution directly in the manipulated variable space). Other variations of the proposed methods arising from using combined batch-wise and observation-wise unfolding, different variants of the missing data imputation methods, or different latent variable estimation approaches could be easily made by a person skilled in the art.

### Control Using PCA Latent Variable Model of the Batch-Wise Unfolded Data

Control in the LV Space

In one aspect of the present invention, a multi-phase PCA model is developed based on a batch-wise unfolded dataset. The objective of the control may be to run a new batch to track certain trajectories and compensate for the effects of disturbances entering the batch. Assume a new batch is currently at sample time k. For any phase the information of each sample time is included in ζₖ as defined by:

ζₖ^{T}=[x_{me,k}^{T},y_{cv,k}^{T},u_{c,k}^{T},y_{sp,k}^{T}] (17)

Where xₘₑ, y_{cv}, u_{c}, and yₛₚ are measured variables, controlled variables, manipulated variables, and set point variables, respectively. The existing information in the current batch phase can be separated as follows according to whether it is known past or present data or unknown future values:

$$\begin{matrix}\begin{matrix}{x}^{T} = [ {ζ}_{1}^{T} , {ζ}_{2}^{T} , … , {ζ}_{k}^{T} , … , {ζ}_{K}^{T} ] \\ = [ \begin{matrix}\begin{matrix}{ζ}_{j}^{T} {\vert}_{j = 1 : k - 1} , {x}_{me , k}^{T} , {y}_{cv , k}^{T} , {y}_{sp , k}^{T} {y}_{sp , j}^{T} {\vert}_{j = k + 1 , … , k + K} \\ {u}_{c , k}^{T} , {u}_{c , j}^{T} {\vert}_{j = k + 1 , … , k + K - 1} , {x}_{me , j}^{T} {\vert}_{j = k + 1 , … , k + K}\end{matrix} \\ {y}_{cv , j}^{T} {\vert}_{j = k + 1 , … , k + K}\end{matrix} ] \\ = [ {x}_{P 1}^{T} , {x}_{P 2}^{T} ; {x}_{f 1}^{T} , {x}_{f 2}^{T} ]\end{matrix} & ( 18 )\end{matrix}$$

where, x_{P1}^{T}=(ζⱼ^{T}|_{j=1:k-1}, x_{me,k}^{T}, y_{cv,k}^{T}, y_{sp,k}^{T}) and x_{P2}^{T}=(y_{sp,j}^{T}|_{j=k+1:K}) are vectors of the known information at time k, while x_{f1}^{T}=(u_{c,k}^{T}, u_{c,j}^{T}|_{j=k+1:k+K-1}, x_{me,j}^{T}|_{j=k+1:k+K}) and x_{f2}^{T}=(y_{cv,j}^{T}|_{j=k+1:K}) are future data that are not known yet and K is the total duration of the batch or phase. Separating the loading vectors in the corresponding manner to the division of x, we have:

P=[P_{P1};P_{P2};P_{f1};P_{f2}] (19)

Note that since the algorithm is presented for online application, all of the variables mentioned in Equations (17) to (19) change over time and must have an index “k”. However, for the sake of brevity the index “k” may be omitted in the following derivations.

Under MPC control at the current time (k), the phase is not complete and the projected scores at the end of the batch assuming no further control moves are to be taken, must be estimated from only the data available up to and including the time step k using a missing data imputation method. A correction to the score (Δ\hat{τ}ₖ) is then estimated by optimizing the MPC objective function and the corrected final score can be calculated as:

τ_{kc}=\hat{τ}ₖ+Δ\hat{τ}ₖ (20)

The objective function of the optimal control can be represented as follows:

$${min}_{Δ {\hat{τ}}_{k}} 1 / 2 {( {\hat{y}}_{cv} - {y}_{sp} )}^{T} {V}_{1} ( {\hat{y}}_{cv} - {y}_{sp} ) + {\hat{u}}_{f}^{T} {V}_{2} {\hat{u}}_{f} = 1 / 2 {( {\hat{x}}_{f 2} - {x}_{P 2} )}^{T} {V}_{1} ( {\hat{x}}_{f 2} - {x}_{P 2} ) + {\hat{u}}_{f}^{T} {V}_{2} {\hat{u}}_{f} \qquad ( 21 )$$

The first term penalizes the deviation of the controlled variables (ŷ_{cv}) from their setpoint trajectories (yₛₚ), while the second term is a move suppression term that penalizes the amount of movement allowed in the manipulated variables computed by the controller (û_{f}). Define:

xₚ^{T}=[x_{P1}^{T}x_{P2}^{T}],

x_{f}^{T}=[x_{f1}^{T}x_{f2}^{T}]

Pₚ^{T}=[P_{P1}^{T}P_{P2}^{T}],

P_{f}^{T}=[P_{f1}^{T}P_{f2}^{T}] (22)

From the PCA model (equation (7):

\hat{τ}ₖ+Δ\hat{τ}ₖ=Pₚ^{T}\hat{x}_{p,k}+P_{f}^{T}\hat{x}_{f,k} [symbol] P_{f}^{T}\hat{x}_{f,k}=\hat{τ}ₖ+Δ\hat{τ}ₖ−Pₚ^{T}\hat{x}_{p,k} (23)

Then, in this example of the present invention, using the same analysis presented in Flores-Cerrillo and MacGregor (2004) the future values of the variables may be obtained to be consistent with the past information in a PLS model. This analysis may be modified to be used with a PCA or other model. Following this consideration and after some rearrangements, the output and input variables can be written in terms of scores of the batch:

\hat{x}_{f2}=P_{f2}(P_{f}^{T}P_{f})⁻¹(\hat{τ}ₖ+Δ\hat{τ}ₖ−Pₚ^{T}x_{p,k}) (24a)

u_{f}=P_{uf}(\hat{τ}ₖ+Δ\hat{τ}ₖ) (24b)

Substituting Equations (24a) and (24b) into the objective function, Equation (21), and solving the optimization problem, we get the optimal correction to the scores which can be used along with Equation (20) to get the optimal score of the batch and then optimal û_{f}. If there is no constraint, it is straightforward to find the analytical solution for the above optimal problem. If there are linear inequality constraints that must be respected on any of the variables, the optimization can be posed as a general quadratic programming problem and solved subject to the constraints. Constraints on the manipulated variables may be projected into the latent variable space and explicitly considered in this space as functions of the latent variable scores.

Control in the Manipulated Variable Space

In another alternative of the present invention control can be in the manipulated variable space. The data for the current batch may be partitioned in a more explicit way with respect to the manipulated variable:

$$\begin{matrix}\begin{matrix}{x}^{T} = [ {ζ}_{1}^{T} , {ζ}_{2}^{T} , … , {ζ}_{k}^{T} , … , {ζ}_{K}^{T} ] \\ = [ \begin{matrix}{ζ}_{j}^{T} {\vert}_{j = 1 : k - 1} , {x}_{me , k}^{T} , {y}_{cv , k}^{T} , {y}_{sp , k}^{T} {y}_{sp , j}^{T} {\vert}_{j = k + 1 , … , k + PH} \\ {x}_{me , j}^{T} {\vert}_{j = k + 1 , … , k + PH} {y}_{cv , j}^{T} {\vert}_{j = k + 1 , … , k + PH} {u}_{c , j}^{T} {\vert}_{j = k , … , k + CH}\end{matrix} ] \\ = [ {x}_{P 1}^{T} , {x}_{P 2}^{T} {x}_{f 1}^{T} , {x}_{f 2}^{T} , {u}_{f} ]\end{matrix} & ( 25 )\end{matrix}$$

Where PH and CH are (Model) Prediction and Control horizons, respectively x_{P1}^{T}=(ζⱼ^{T}|_{j=1:k-1},x_{me,k}^{T},y_{cv,k}^{T},y_{sp,k}^{T}), x_{P2}^{T}−(y_{sp,j}^{T}|_{j=k+1:k+PH}), x_{f1}^{T}=(x_{me,j}^{T}|_{j=k+1:k+PH}), x_{f2}^{T}=(y_{cv,j}^{T}|_{j=k+1:k+PH}), and u_{f}=(u_{c,k}^{T},u_{c,j}^{T}|_{j=k+1:k+CH}). A key point of this method is to formulate the problem in terms of future manipulated variables, u_{f}. At the sample time k, the known data are x_{P1}, x_{P2}, the unknown data are x_{f1}, x_{f2}, and the future decision variable is u_{f}. The term u_{f} will be determined through the optimization process. As a result, to develop the control algorithm, the score estimation method has to be defined first. The method used in this study is the TSR method but use of other methods is contemplated, Equation (16).

Once the scores are estimated the future output variables may be estimated as well:

\hat{x}_{f2}=P_{f2}\hat{τ}ₖ (26)

One may use the Equation (26) in the optimization problem, Equation (21), with the modification of considering u_{f} as the decision variable instead of Δ\hat{τ}, to obtain the optimal u_{f} as the solution to the optimization problem. If there are hard constraints that must be respected on any of the variables, the optimization can be posed as a general quadratic programming problem and solved subject to the constraints.

Control Based on a PCA Latent Variable Model Using Observation-Wise Unfolded Data with Time-Lagging

In another embodiment of the present invention, the control algorithm for a PCA model based on time-lagged observation-wise unfolded data (FIG. 3) may follow the same structure as that for the PCA model on batch-wise unfolded data. Only a few considerations must be taken into account:
1—In order to match the size of the new observation with that of observations considered in the time-lagged variable-wise unfolded data set, only a specified past and future horizon of data may be considered. Equation (5) shows that the total number of columns in each observation is K*(PH+FH+1), where K is the total number of variables considered at each time step for model building (measurements+manipulated variables+controlled variables+set point variables). Each time step may be considered as a new observation with respect to the model where the current time is at the middle of the window. Therefore, at each time step only information from time (i−PH) to time (i+FH) is needed. That means in Equations (18) or (25) instead of considering information from the beginning of the phase till the end of model horizon, only the information from time (i−PH) to time (i+FH) may be considered.
2—The other point is that since the future horizon (FH) is typically small (less than 40-50 sample times) one might consider an equal value for both the control horizon and the model prediction horizon in Equation (25). However this is not mandatory. For example if FH=15, it is logical to assume CH=PH=15, while if FH=45 one might assume CH=15, but PH=45.

### Control Based on the Combined Batch-Wise and Observation-Wise Unfolded Data

In another alternative of the present invention, the control based on combined batch-wise and observation-wise unfolded data (FIG. 4) follows the same rules as that of a batch-wise unfolded dataset. The only difference may be that when L time lags are considered in the dataset, the number of effective sample times in the unfolded dataset reduces to K-L. In the application of LV-MPC to a pure batch-wise unfolded dataset one may have to apply another controller such as PI (proportional-integral) for the beginning and end of the batch since the LV-MPC approach may be applicable as long as there are as many past and future sample times as ph and fh in the dataset. These beginning and end effects will be expanded to ph+L and fh+L when the combined batch-wise and observation-wise unfolded dataset is used for the LV-MPC approach.

### Implementation

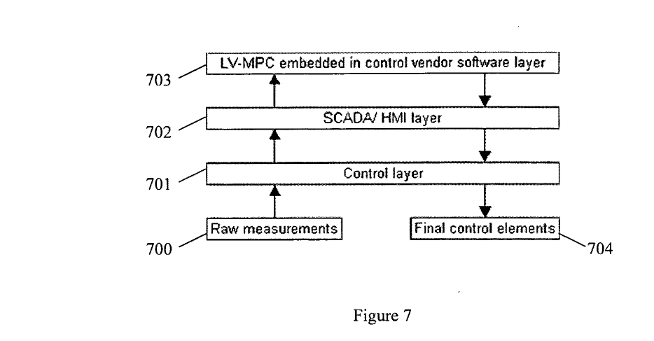

In one implementation of the present invention, the latent variable model predictive control (LV-MPC) technology for transitional processes (such as batch processes or continuous processes during grade transitions, startups and shutdowns) may be readily implemented within the existing hardware and software environments provided by many of the existing control vendors, such as Emerson, Aspen Technologies, Honeywell, Rockwell Automation and others. ProSensus also has access to its own in-house software platform for this purpose. FIG. 7 illustrates a simplified diagram of the typical hardware and software infrastructure.

In one embodiment of the present invention as illustrated in FIG. 7, the raw measurements (700) which may include temperatures, pressures, NIR instruments, etc., may pass from a control layer (701) such as a PLC, Programmable Logic Controller or DCS, Distributed Control System, up to the Supervisory Control and Data Acquisition (SCADA)/Human Machine Interface (HMI) layer (702). From there the data may be passed to the control vendor's software platform (703). The core LV-MPC algorithms may reside in this software layer, acting on the input measurements from the process to calculate the optimal control outputs. These outputs may then written out from the vendor software platform to the SCADA/HMI (702) layer, and from there down past the control layer (701) to the actual final control elements (704. The final control elements (704) may be an actual control valve or the setpoint of a low-level control loop such as PID, Proportional Integral Derivative that resides in the control layer (e.g., in the PLC or other controller). Other control elements and control layers are contemplated.

Alternatively, the technology of the present invention may be implemented as a computer program, operable on a computer to implement the method of the present invention, and constitute a computer system operable to provide the functionality described in the present invention. The computer system or computer program of the present invention may be configured to interoperate the third party hardware or software systems described above.

### Example in Operation

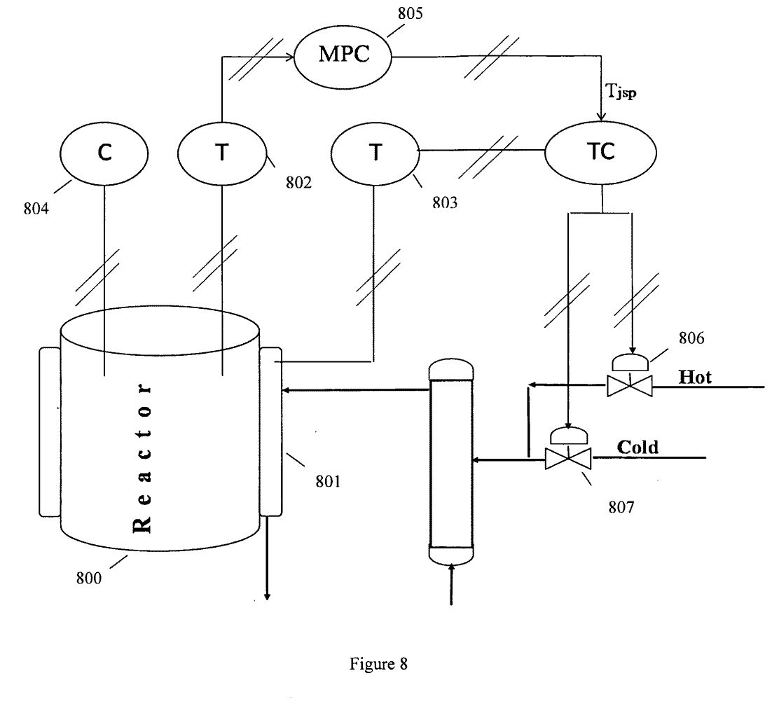

Aziz, N., Hussain, M. A., Mujtaba, I. M., (2000), Performance of different types of controllers in tracking optimal temperature profiles in batch reactors, Comput. Chem. Eng. 24, 1069-1075, presented a nonlinear model of a batch reactor. This case study was originally proposed by Cott, B. J., Macchietto, S., (1989), Temperature control of exothermic batch reactors using generic model control, Ind. Eng. Chem. Res. 28 (8), 1177-1184, as a case study for a temperature control problem in a batch reactor. The schematic figure of the reactor is shown in FIG. 8. In a simulation of the present invention, this case study is considered below.

The objective is to control the reactor (800) temperature to track a desired trajectory and simultaneously reject disturbances entering the process. The manipulated variable is the set point of the jacket (801) temperature (FIG. 8) and the measured variables are the reactor temperature (802), jacket temperature (803) and the concentrations (804). Once the set point is calculated by the MPC (805), then by combining the flows of hot water (806) and cold water (807), the desired input temperature to the jacket is generated immediately. However, it takes time for the average jacket temperature (Tⱼ) to achieve the Tₛₚ (input).

The following figures show the performance of the proposed variations of the methodology used for both the tracking of a complex trajectory and for non-stationary disturbance rejection where a random walk disturbance has been added to the calculated reactor temperature.

a. Control Studies Using PCA Models Based on Batch-Wise Unfolded Data:

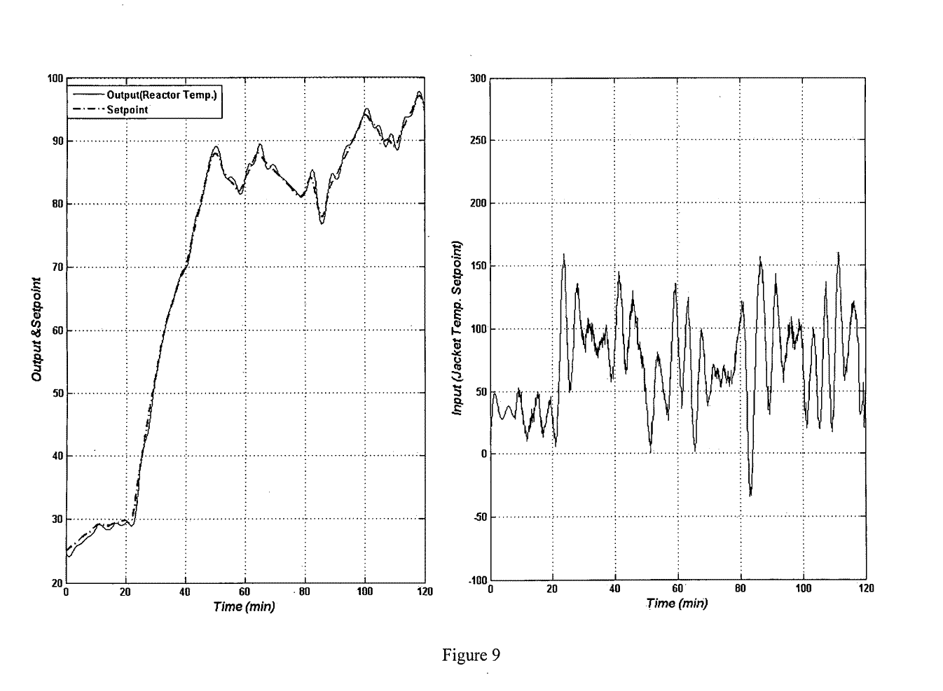

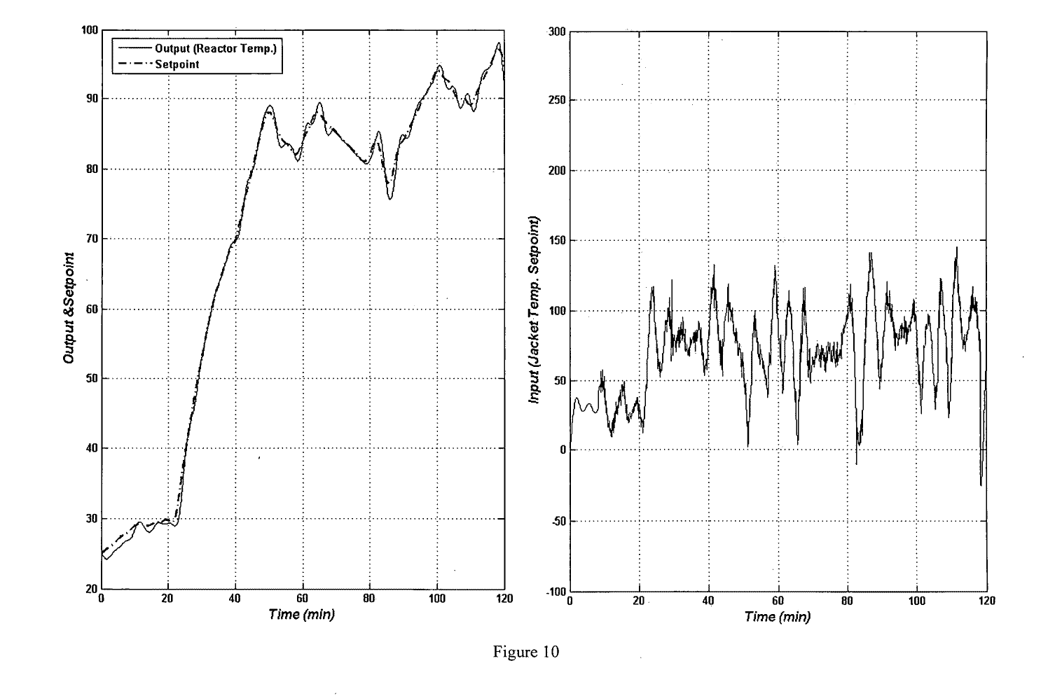

FIGS. 9 and 10 illustrate the LV-MPC algorithm, based on PCA models for batch-wise unfolded data, for the tracking of the reactor temperature set-point trajectory when there are no non-stationary disturbances present (only white noise errors have been added to the measured temperatures). FIGS. 9 and 10 show the performance of the MPC based on optimization in the latent variable score space and the manipulated variable space, respectively. The desired output temperature set-point trajectory (yₛₚ) and the output temperature (y) achieved through implementation of the proposed LV-MPC algorithm are shown by solid and dashed lines, respectively, in the left hand graph, and the input manipulated variable (jacket temperature set-point, u) is shown in the right hand graph.

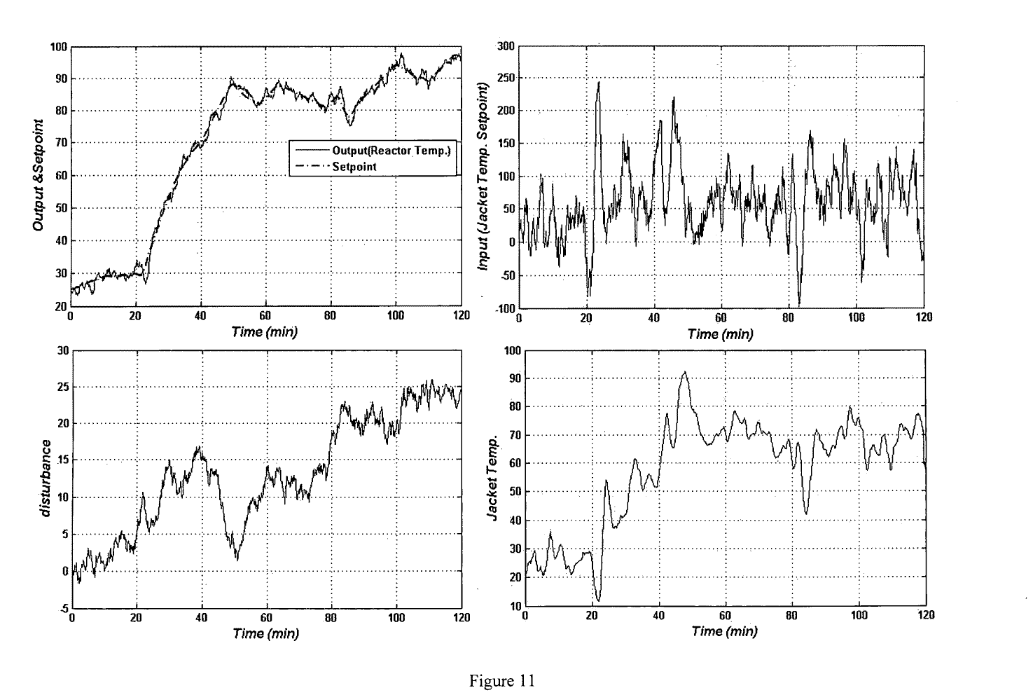

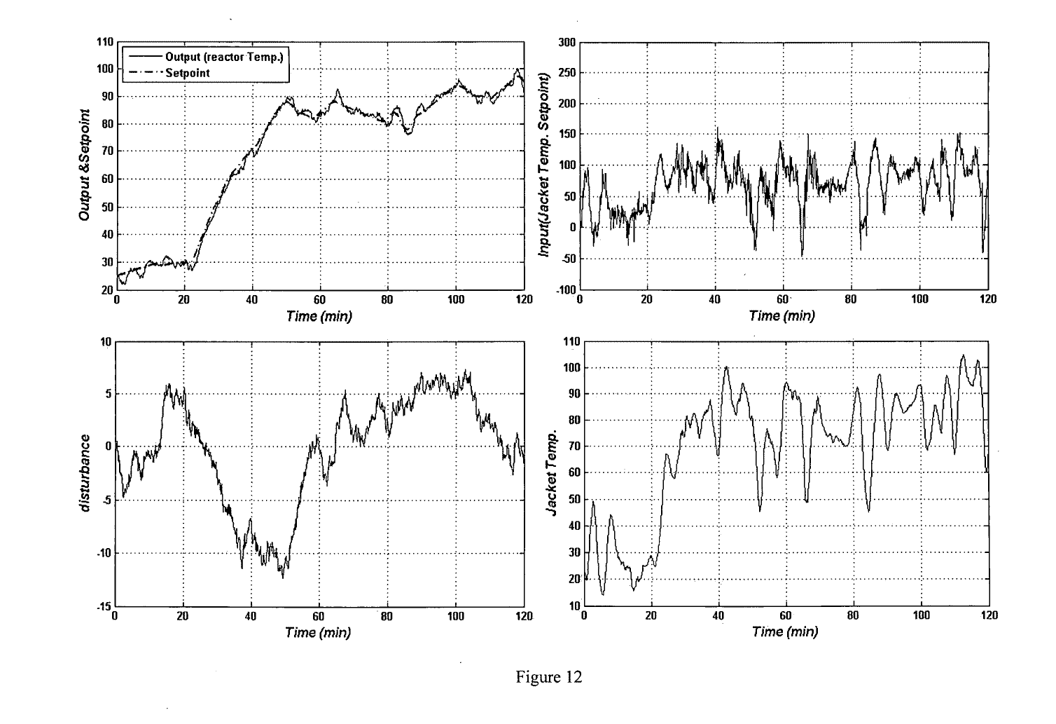

FIGS. 11 and 12 illustrate the performance of the same two algorithms when a non-stationary random walk is also present in the temperature measurements. Plots of the disturbance added to the reactor temperature are shown. Note that the LV-MPC has effectively eliminated much of this disturbance from the final controlled temperature, and shows no persistent bias or offset, thereby illustrating that the LV-MPC contains integral type action.

These figures illustrate the ability of these algorithms to simultaneously track the temperature set-point trajectory and compensate for non-stationary disturbances.

b. Control Studies Using PCA Models Based on Time-Lagged Observation-Wise Unfolded Data

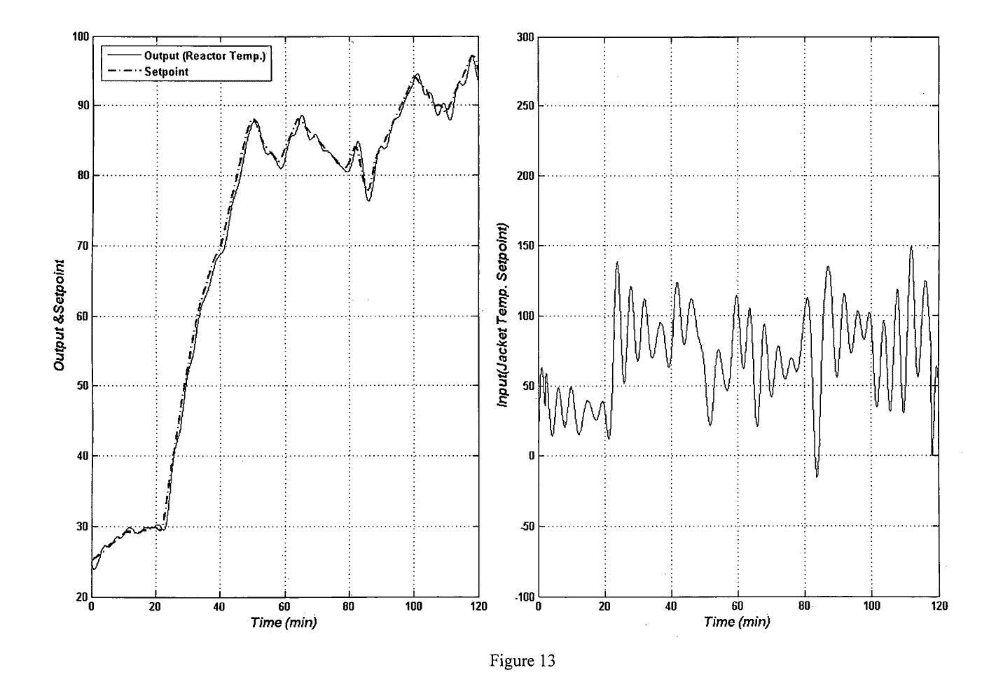

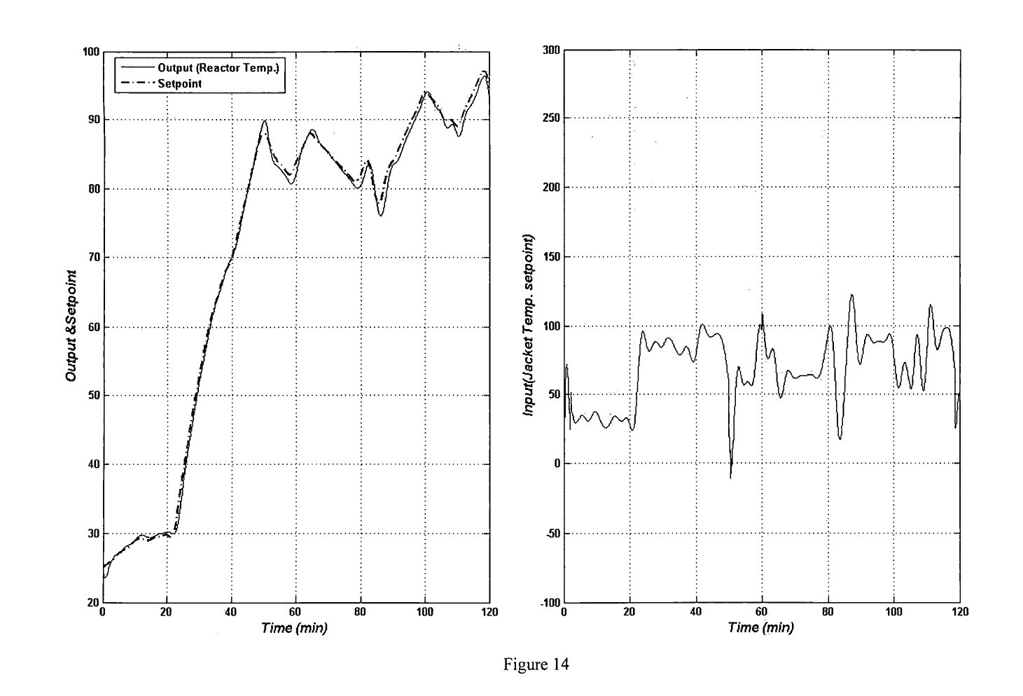

FIGS. 13 and 14 illustrate the LV-MPC algorithm based on PCA models, for the time lagged observation-wise unfolded data, for the tracking of the reactor temperature set-point trajectory when there are no non-stationary disturbances present (only white noise errors have been added to the measured temperatures). The left hand plots in these figures again show the output temperature setpoint trajectories (solid line) and the resulting output temperatures achieved as a result of applying the proposed LV-MPC algorithm. FIGS. 13 and 14 show the performance of the LV-MPC based on optimization in the latent variable score space and optimization in the manipulated variable space, respectively.

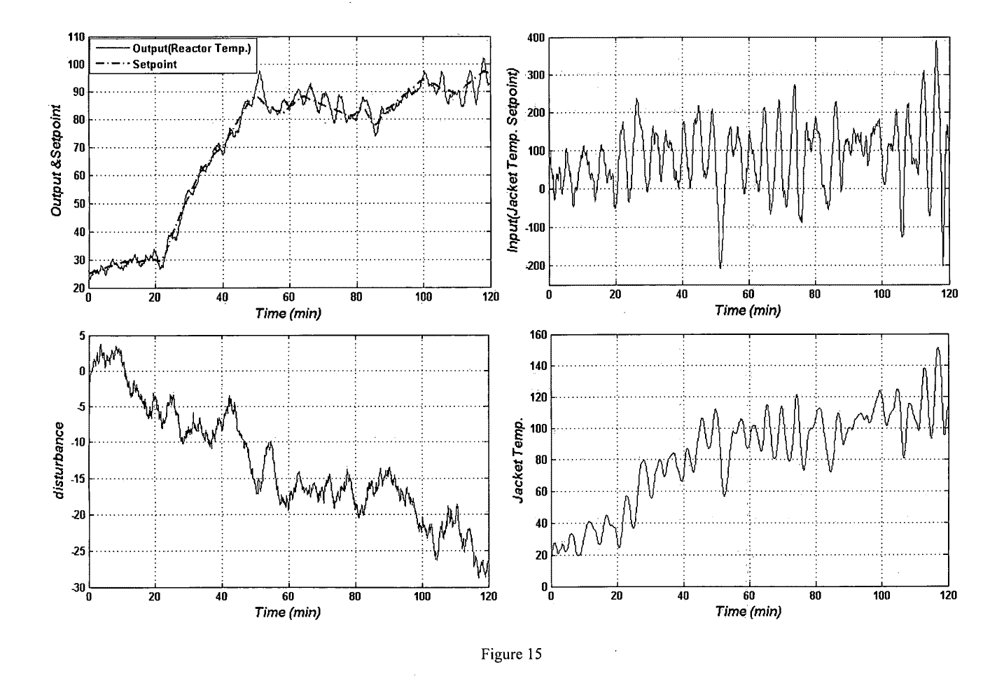

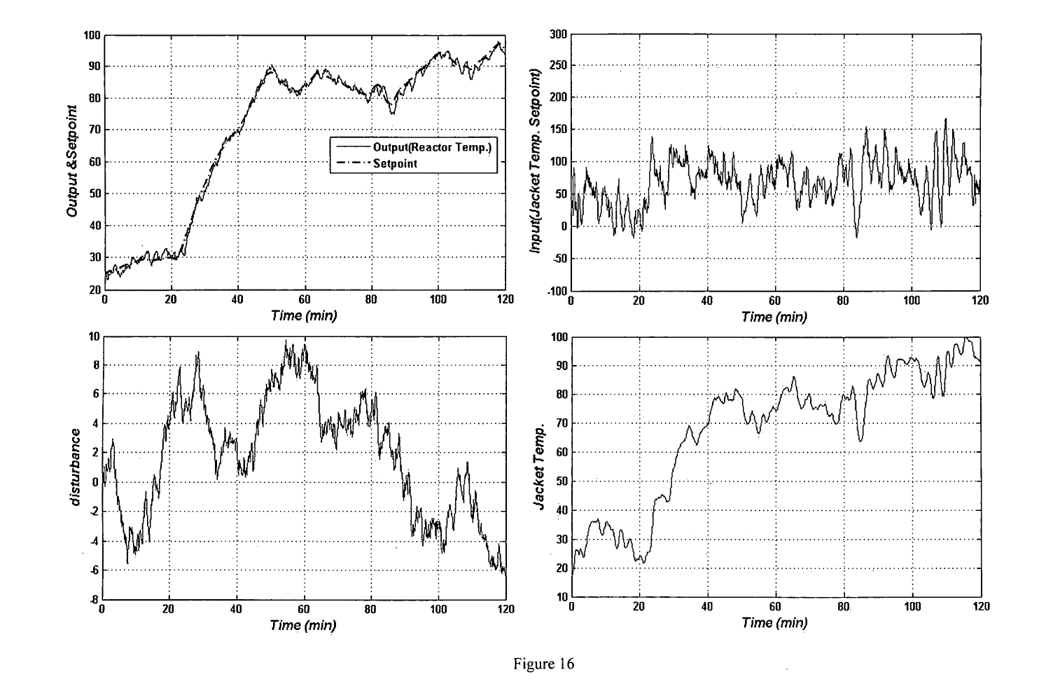

FIGS. 15 and 16 illustrate the performance of the same two algorithms when a non-stationary random walk (shown in the lower left hand plot in the Figures) is also present in the temperature measurements. These figures illustrate the ability of these algorithms to simultaneously track the temperature set-point trajectory and compensate for non-stationary disturbances.

### Further Examples

The present invention may have a wide range of potential industrial applications in the batch manufacturing industry. To illustrate the nature and range of some possible industrial applications the following examples are presented, but are not intended to be exhaustive:
(i) One implementation of the present invention may be the control of temperature, pressure and concentration trajectories in the batch manufacture of chemicals and polymers. In these processes it is usually desired to have one or more of these process variables track desired trajectories (referred to as set-point trajectories) that vary from the start to the end of the batch. For example, the process may be heated by manipulating the flow of heating and cooling fluids (manipulated variables, u₁, u₂) to a jacket surrounding the vessel in order to increase the measured temperature (a controlled variable, y₁) of the contents of the batch reactor to a desired level, hold the temperature constant for a period of time and then decrease or increase the temperature in some desired manner until the end point of the batch. The shape or behavior of the desired temperature history over the duration of the batch is referred to as the set-point temperature trajectory. At the same time the flow of a raw material or reactant (another manipulated variable, u₃) may be manipulated over the duration of the batch in order to control the measured concentration (y₂) of a material in the reactor to follow its desired set-point trajectory. Also at the same time, the reactor pressure (y₃) may have to be controlled to be within certain limits throughout the course of the batch by manipulating a pressure relief valve or a pump (u₄). Each of these manipulated variables (u) may have some impact on several or all of the controlled variables (y) and so the control methodology must model and control all these variables simultaneously. In addition there will usually exist many additional measured variables (xₘₑ) such as agitator power, pH, jacket temperature, or possibly vibrational spectra from an in-line Near InfraRed (NIR) or Raman spectrometer. These additional measurements should also be used in any efficient MPC control scheme since they bring additional information on the disturbances affecting the future direction of the process.

The following are several additional example applications from other batch material processing industries that are very similar in nature to the application described above:
(ii) The control of pH, dissolved oxygen, and nutrient concentration trajectories in the semi-batch manufacture of biological materials through the manipulation of oxygen flow, pH modifier flow, and nutrient flow to the reactor.
(iii) The control of temperature, supersaturation and particle growth trajectories in batch crystallization.
(iv) The control of temperature, mixing intensity and viscosity trajectories in food processing.
(v) The control of partial pressure and temperature trajectories in vapor phase deposition or etching in the manufacture of silicon chips in the semi-conductor industry.

Other examples may be as follows:
(vi) Injection molding or reaction injection molding: The control of these processes for the manufacture of plastic parts, automotive seats, etc. may be accomplished with use of the present invention. In this case the pressure trajectory (y) over the course of the injection of the materials into the mold might be controlled through manipulating the speed of the injection lance (u).
(vii) Robotics: Control over the three dimensional trajectories of movement (position and velocity over the duration of the movement) of a robotic arm or machine through manipulation of the forces applied by the motors.
(viii) Medical treatment: The control of patient treatment over a finite period of time. This might involve the controlled dosage of a drug (u) given to a patient over a period of time based on achieving a desired measured response (y) from the patient. The set-point trajectory (yₛₚ) is the desired patient response over the duration of the treatment period.

The following are examples of where the proposed LV-MPC may be applied to transitional operation of continuous processes:
(ix) Control of product grade transitions in continuous production processes. An example is in the manufacture of polyolefins in a fluidized bed reactor, where it is desired to transition from one grade of polyolefin with a specified set of properties (melt index, density) to another grade with a different set of properties over a specified time interval. In this case the temperature and partial pressure trajectories of the gases and the rate of production could be controlled to follow specified set-point trajectories by manipulating the inlet flows of gases, the venting rate of gases, the catalyst injection rate and the coolant flow to the heat exchanger.
(x) Start-up of a continuous chemical reactor (such as the polyolefin fluidized bed reactor described above) where it is desired to ramp up the reactor temperature according to a desired set-point trajectory and to control the partial pressures of the gases and production rate to follow other specified trajectories to reach a desired steady state operating condition.
(xi) Supply chain management: A company may be interested in controlling the deliveries and inventories (y) in its supply chain over certain transition periods such as the period leading up to Thanksgiving or Christmas, or during the phase-in of a new product by manipulating the production rate of the product and the shipments (u) from the plants to its distribution centers according to some desired time behavior.

### LITERATURE REFERENCES

Arteaga, F., Ferrer A., (2002), Dealing with missing data in MSPC: several methods, different interpretations, some examples, J. Chemometrics 16, 408-418.
Aziz, N., Hussain, M. A., Mujtaba, I. M., (2000), Performance of different types of controllers in tracking optimal temperature profiles in batch reactors, Comput. Chem. Eng. 24, 1069-1075.
A. J. Burnham, R. Viveros-Aquilera and J. F. MacGregor, 1996. “Objective Function Frameworks for Comparing Latent Variable Methods for Multivariate Regression”, J. Chemometrics, 10, 31-46.
Camacho, J., Pico, J., (2006), Multi-phase principal component analysis For batch processes modeling, Chemometrics and Intelligent Laboratory systems, Vol. 81, 127-136.
Camacho, J., Pico, J., Ferrer, A., (2009) The best approaches in the on-line monitoring of batch processes based on PCA: Does the modeling structure matter?, Analytica Chimica Acta, Article in Press
Cott, B. J., Macchietto, S., (1989), Temperature control of exothermic batch reactors using generic model control, Ind. Eng. Chem. Res. 28 (8), 1177-1184.
Flores-Cerrillo, J., MacGregor, J. F., (2004), Control of batch product quality by trajectory manipulation using latent variable models, J. Process Cont. 14, 539-553.
Flores-Cerillo, J. and J. F. MacGregor, (2005) “Latent variable MPC for Trajectory Tracking in Batch Processes, J. Process Control, 15, 651-663.
Louwerse D. J., Smilde A. K., (2000), “Multivariate statistical process control of batch processes based on three-way models”, Chemical Engineering Science 55, 1225-1235.
P. Nelson, P. A. Taylor and J. F. MacGregor, (1996) “Missing Data Methods in PCA and PLS: Score Calculations with Incomplete Observations”, J. Chemometrics & Intell. Lab. Syst., 35, 45-65
Nomikos, P. and MacGregor, J. F., (1994), “Monitoring of Batch Processes Using Multi-Way Principal Components Analysis”, Amer. Inst. Chem. Eng. J., 40, 1361-1375.
P. Nomikos and J. F. MacGregor, (1995). “Multi-Way Partial Least Squares in Monitoring Batch Processes”, Chemometrics & Intell. Lab. Systems, 30, 97-108.

What is claimed is:

1. A computer implemented method for modelling and controlling batch or transitional processes comprising the steps of:
a. collecting, or initiating the collection of measurements on a plurality of process variables;
b. creating, or initiating the creation of, a latent variable model predictive controller (MPC) based on the collected measurements; and
c. applying, or initiating the application of, the model predictive controller to predict and control at least one of the process variables to track a desired trajectory, by operation of at least one computer including one or more computer processors.

2. The method of claim 1 wherein applying the latent variable model predictive controller includes the further step of imputing unmeasured future values of at least one process variable of the batch or transitional process using a missing data imputation method for a latent variable model.

3. The method of claim 1 wherein the latent variable model of the batch or transitional process is established using one of the following latent variable methods: Principal Component Analysis (PCA); Independent Component Analysis (ICA); Partial Least Squares (PLS); Redundancy Analysis (RA) (sometimes referred to as Reduced Rank regression (RRR)); and Canonical Correlation Analysis (CCA).

4. The method of claim 1 wherein the latent variable model predictive controller is built using data matrices established using batch-wise unfolding of a batch data array, such that each row of an unfolded matrix corresponds to a unique batch, and each column to unique variables at unique points in time.

5. The method of claim 4 wherein the data are segmented into a plurality of time blocks and multiple models are used, one for each time block.

6. The method of claim 1 wherein the latent variable model predictive controller is built on data matrices obtained from time lagged, observation-wise unfolding of the data array, such that each row contains time lagged observations of variables over a predetermined time window.

7. The method of claim 6 wherein the data are segmented into a plurality of batch phases or time blocks and multiple models are used, one for each time block.

8. The method of claim 1 wherein the latent variable model predictive controller is built using data matrices obtained using a combination of batch-wise and observation-wise unfolding of the data array.

9. The method of claim 8 wherein the data are segmented into a plurality of batch phases or time blocks and multiple models are used, one for each time block.

10. The method of claim 1 wherein the model predictive control action is obtained by solving a quadratic optimization problem, with or without linear inequality constraints.

11. The method of claim 10 wherein the MPC optimization is performed in the space of at least one latent variable and the at least one manipulated variable trajectory is then computed from the optimized latent variable scores.

12. The method of claim 10 wherein the MPC optimization is performed directly in the space of the manipulated variables.

13. The method of claim 12 wherein linear inequality constraints on the manipulated variables are considered in the generating of the desired trajectories.

14. The method of claim 13 wherein linear inequality constraints of the manipulated variables are projected into the latent variable space and explicitly considered in this space as functions of the latent variable scores.

15. The method of claim 12 wherein move suppression on the manipulated variables is explicitly considered.

16. The method of claim 15 wherein the move suppression term for the manipulated variables is projected into the latent variable space and then explicitly considered in terms of the latent variable scores.

17. A system for modelling and controlling batch or transitional processes comprising:
a. one or more computers including or being linked to a computer program, the computer program including computer instructions which when made available to the one or more computers, is operable to provide:
i. a control layer for collecting or initiating the collection of measurements on a plurality of process variables, and further for creating or initiating the creation of a latent variable model predictive controller based on the collected measurements, wherein the control layer is operable to apply or initiate the application of the model predictive controller for predicting and controlling at least one of the process variables to track a desired trajectory.

18. The system of claim 17 wherein the model predictive controller is operable to impute unmeasured future values of at least one process variable of the batch process using a missing data imputation method for a latent variable model.

19. The system of claim 17 wherein the latent variable model predictive controller is built using data matrices obtained from batch-wise unfolding of a batch data array, such that each row of an unfolded matrix corresponds to a unique batch, and each column to unique variables at unique points in time.

20. The system of claim 17 wherein the latent variable model predictive controller is built on data matrices obtained from time lagged, observation-wise unfolding of the data array, such that each row contains time lagged observations of variables over a predetermined time window.

21. The system of claim 17 wherein the latent variable model predictive controller is built using data matrices obtained using a combination of batch-wise and observation-wise unfolding of the data array.

22. A computer program comprising computer instructions, which when made available to one or more computers, are operable to define on the one or more computers:
a. a control layer configured to collect or initiate the collection of measurements on a plurality of process variables, and to create or initiate the creation of a latent variable model predictive controller based on the collected measurements, wherein the control layer is operable to apply or initiate the application of the model predictive controller predict and control at least one of the process variables to track a desired trajectory.

23. The computer program of claim 22 wherein the linear model predictive controller is operable to impute unmeasured future values of at least one process variable of the batch process using a missing data imputation method for the latent variable model.

24. The computer program of claim 22 wherein the latent variable model predictive controller is built using data matrices obtained from batch-wise unfolding of a batch data array, such that each row of an unfolded matrix corresponds to a unique batch, and each column to unique variables at unique points in time.

25. The computer program of claim 22 wherein the latent variable model predictive controller is built on data matrices obtained from time lagged, observation-wise unfolding of the data array, such that each row contains time lagged observations of variables over a predetermined time window.

26. The computer program of claim 22 wherein the latent variable model predictive controller is built using data matrices obtained using a combination of batch-wise and observation-wise unfolding of the data array.
